(19) United States
(12) Patent Application Publication
(10) Pub. No.: US 2022/0321012 A1
(43) Pub. Date: Oct. 6, 2022

(54) SWITCHING REGULATOR ACHIEVEING SOFT SWITCHING BY DOUBLE SWITCHING AND CONTROL CIRCUIT THEREOF

(71) Applicant: Richtek Technology Corporation, Zhubei City (TW)

(72) Inventors: Yong-Cyuan Chen, Hsinchu (TW); Tzu-Chen Lin, Changhua (TW); Yi-Wei Lee, Taipei (TW); Ta-Yung Yang, Taoyuan (TW)

(21) Appl. No.: 17/711,343

(22) Filed: Apr. 1, 2022

Related U.S. Application Data
(60) Provisional application No. 63/169,276, filed on Apr. 1, 2021.

(30) Foreign Application Priority Data
Oct. 13, 2021 (TW) 110137971

(51) Int. Cl. H02M 3/158; H02M 1/00

(52) U.S. Cl. CPC H02M 3/1582; H02M 1/0058

(57) ABSTRACT

A switching regulator includes a first switch, a second switch, an inductor coupled to the first and second switches, and a control circuit. The control circuit controls the first switch to be ON for an ON time period. Next, the control circuit controls the first and second switches to be OFF for a first dead time period. Next, the control circuit controls the second switch to be ON for a synchronous rectification time period. Next, the control circuit controls the first and second switches to be OFF for a second dead time period. Next, the control circuit controls the second switch to be ON for a zero-voltage-switching pulse time period. Next, the control circuit controls the first and second switches to be OFF for a third dead time period. By the above operations, the first switch achieves soft switching.

### CROSS REFERENCE

The present invention claims priority to U.S. 63/169,276 filed on Apr. 1, 2021 and claims priority to TW 110137971 filed on Oct. 13, 2021.

### BACKGROUND OF THE INVENTION

### Field of Invention

The present invention relates to a switching regulator and a control circuit thereof; particularly, it relates to such switching regulator and such control circuit capable of achieving soft switching by executing double switching.

### Description of Related Art

Please refer to FIG. 1, which shows waveforms of signals related to the operation of a conventional buck switching regulator. As shown in FIG. 1, during an ON time period from the time point t0 to the time point t1, a control circuit of the conventional buck switching regulator controls an upper gate switch to be ON. During a dead time period from the time point t1 to the time point t2, the control circuit of the conventional buck switching regulator controls the upper gate switch and a lower gate switch to be both OFF. During a synchronous rectification (SR) time period from the time point t2 to the time point t3, the control circuit of the conventional buck switching regulator controls the lower gate switch to be ON. During another dead time period from the time point t3 to the time point t4, the control circuit of the conventional buck switching regulator controls the upper gate switch and the lower gate switch to be both OFF. Next, from the time point t4 to the time point t5 in a next switching period, the control circuit of the conventional buck switching regulator controls the upper gate switch to be ON for another ON time period.

The prior art shown in FIG. 1 has a drawback. As indicated by a dashed arrow in FIG. 1, when the upper gate switch is turned ON (i.e., at the time point t4) in the next switching period, the voltage at the switching node is not equal to the input voltage, which indicates that the voltage across the upper gate switch (i.e., the drain-source voltage of the upper gate switch) is not zero; therefore, in a case when the input voltage is high or the switching frequency is high, there will be high power loss.

In view of the above, to overcome the drawback in the prior art, the present invention proposes a switching regulator and a control circuit thereof which are capable of achieving soft switching by executing double switching.

### SUMMARY OF THE INVENTION

From one perspective, the present invention provides a switching regulator, comprising: a first switch; a second switch; an inductor coupled to the first switch and the second switch, wherein the inductor, a parasitic capacitor of the first switch and a parasitic capacitor of the second switch together constitute a resonant tank; and a control circuit, which is configured to operably control the first switch and the second switch; wherein: the control circuit is configured to operably control the first switch to be ON for an ON time period; subsequent to the ON time period, the control circuit is configured to operably control the first switch and the second switch to be OFF for a first dead time period; subsequent to the first dead time period, the control circuit is configured to operably control the second switch to be ON for a synchronous rectification (SR) time period; subsequent to the SR time period, the control circuit is configured to operably control the first switch and the second switch to be OFF for a second dead time period; subsequent to the second dead time period, the control circuit is configured to operably control the second switch to be ON for a zero-voltage-switching (ZVS) pulse time period; subsequent to the ZVS pulse time period, the control circuit is configured to operably control the first switch and the second switch to be OFF for a third dead time period, whereby the first switch achieves soft switching.

From another perspective, the present invention provides a control circuit, which is configured to operably control a switching regulator, wherein the switching regulator comprises a first switch, a second switch, an inductor coupled to the first switch and the second switch, and the control circuit, wherein the inductor, a parasitic capacitor of the first switch and a parasitic capacitor of the second switch together constitute a resonant tank; the control circuit comprising: a first control unit, which is configured to operably control the first switch; a second control unit, which is configured to operably control the second switch; wherein: the control circuit is configured to operably control the first switch to be ON for an ON time period; subsequent to the ON time period, the control circuit is configured to operably control the first switch and the second switch to be OFF for a first dead time period; subsequent to the first dead time period, the control circuit is configured to operably control the second switch to be ON for a synchronous rectification (SR) time period; subsequent to the SR time period, the control circuit is configured to operably control the first switch and the second switch to be OFF for a second dead time period; subsequent to the second dead time period, the control circuit is configured to operably control the second switch to be ON for a zero-voltage-switching (ZVS) pulse time period; subsequent to the ZVS pulse time period, the control circuit is configured to operably control the first switch and the second switch to be OFF for a third dead time period, whereby the first switch achieves soft switching.

In one embodiment, subsequent to the third dead time period, the control circuit is configured to operably control the first switch to be ON for the ON time period, whereby the first switch achieves soft switching.

In one embodiment, the SR time period is determined according to a demagnetization signal, wherein the demagnetization signal indicates that the inductor has been demagnetized.

In one embodiment, within the ON time period, the inductor generates a positive current.

In one embodiment, within the ZVS pulse time period, the inductor generates a negative current.

In one embodiment, the second dead time period is correlated with a resonant period of the resonant tank.

In one embodiment, the second dead time period is a multiple of the length of the resonant period, so that when the second switch is ON for the ZVS pulse time period, the second switch achieves soft switching.

In one embodiment, the second dead time period is adjustable, whereby a switching period of the first switch is adjustable.

In one embodiment, the control circuit is configured to operably control the first switch and the second switch to operate in a discontinuous conduction mode (DCM).

In one embodiment, the switching regulator is a buck switching regulator, a boost switching regulator or a buck-boost switching regulator, wherein the switching regulator is configured to operably convert an input power to an output power.

In one embodiment, the switching regulator is a buck switching regulator, which is configured to operably convert an input power to an output power, and the buck switching regulator includes: an upper gate switch coupled between the input power and a switching node; and a lower gate switch coupled between the switching node and a ground level; wherein the inductor is coupled between the switching node and the output power; wherein the first switch includes the upper gate switch, whereas, the second switch includes the lower gate switch; wherein the first dead time period is a time period between a time point when the upper gate switch is turned OFF and a time point when the lower gate switch is turned ON; wherein the third dead time period is a time period between a time point when the lower gate switch is turned OFF and a time point when the upper gate switch is turned ON.

In one embodiment, the switching regulator is a boost switching regulator, which is configured to operably convert an input power to an output power, and the boost switching regulator includes: an upper gate switch coupled between the output power and a switching node; and a lower gate switch coupled between the switching node and a ground level; wherein the inductor is coupled between the switching node and the input power; wherein the first switch includes the upper gate switch, whereas, the second switch includes the lower gate switch; wherein the first dead time period is a time period between a time point when the lower gate switch is turned OFF and a time point when the upper gate switch is turned ON; wherein the third dead time period is a time period between a time point when the upper gate switch is turned OFF and a time point when the lower gate switch is turned ON.

In one embodiment, the switching regulator is a buck-boost switching regulator, which is configured to operably convert an input power to an output power, and the buck-boost switching regulator includes: a buck upper gate switch coupled between the input power and a first switching node; and a buck lower gate switch coupled between the first switching node and a ground level; a boost lower gate switch coupled between the second switching node and the ground level; and a boost upper gate switch coupled between the second switching node and the output power; wherein the inductor is coupled between the first switching node and the second switching node; wherein the first switch includes the buck upper gate switch, whereas, the second switch includes the buck lower gate switch; wherein the first dead time period is a time period between a time point when the buck upper gate switch is turned OFF and a time point when the buck lower gate switch is turned ON; wherein the third dead time period is a time period between a time point when the buck lower gate switch is turned OFF and a time point when the buck upper gate switch is turned ON.

In one embodiment, the switching regulator is a buck-boost switching regulator, which is configured to operably convert an input power to an output power, and the buck-boost switching regulator includes: a buck upper gate switch coupled between the input power and a first switching node; and a buck lower gate switch coupled between the first switching node and a ground level; a boost lower gate switch coupled between a second switching node and the ground level; and a boost upper gate switch coupled between the second switching node and the output power; wherein the inductor is coupled between the first switching node and the second switching node; wherein the first switch includes the boost upper gate switch, whereas, the second switch includes the boost lower gate switch; wherein the first dead time period is a time period between a time point when the boost lower gate switch is turned OFF and a time point when the boost upper gate switch is turned ON; wherein the third dead time period is a time period between a time point when the boost upper gate switch is turned OFF and a time point when the boost lower gate switch is turned ON.

Advantages of the present invention include: that, when operating in a buck mode, the present invention controls the lower gate switch to execute double switching and generates a negative inductor current during a switching period, so that the upper gate switch achieves soft switching; that, when operating in a boost mode, the present invention controls an upper gate switch to execute double switching and generates a negative inductor current during a switching period, so that the lower gate switch achieves soft switching; and that, via the above-mentioned two operation mechanisms, the present invention can improve switching efficiency and reduce switching loss, and achieve soft switching without requiring extra devices.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows waveform diagrams of signals related to the operation of a conventional buck switching regulator.

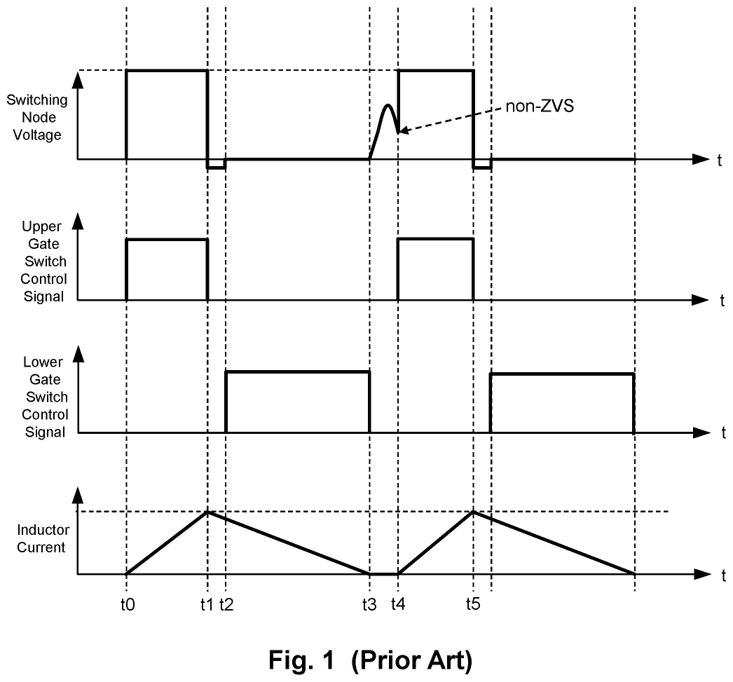

FIG. 2 shows a schematic circuit block diagram of a switching regulator according to an embodiment of the present invention.

FIG. 3 shows a schematic circuit block diagram of a buck switching regulator according to an embodiment of the present invention.

FIG. 4 shows waveform diagrams of signals related to the operation of the buck switching regulator of FIG. 3.

FIG. 5 shows a schematic circuit block diagram of a boost switching regulator according to an embodiment of the present invention.

FIG. 6 shows waveform diagrams of signals related to the operation of the boost switching regulator of FIG. 5.

FIG. 7 shows a schematic circuit block diagram of a buck-boost switching regulator according to an embodiment of the present invention.

FIG. 8 and FIG. 9 show waveform diagrams of signals related to the operation of the buck-boost switching regulator of FIG. 7.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

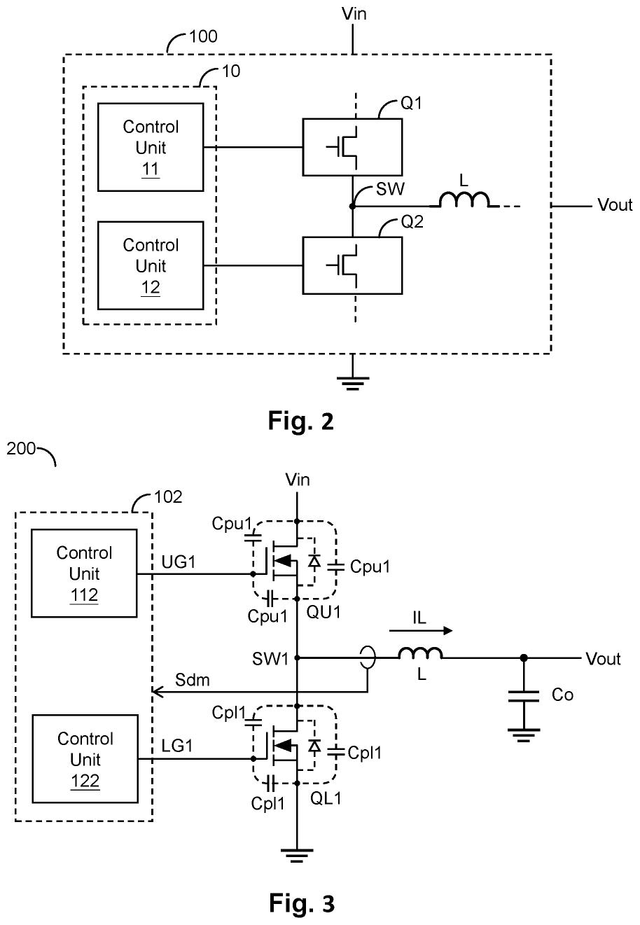

Please refer to FIG. 2, which shows a schematic circuit block diagram of a switching regulator according to an embodiment of the present invention. As shown in FIG. 2, the switching regulator 100 of the present invention includes: a first switch Q1, a second switch Q2, an inductor L and a control circuit 10. The inductor L, the first switch Q1 and the second switch Q2 are commonly coupled to a switching node SW. The control circuit 10 is configured to operably control the first switch Q1 and the second switch Q2. The control circuit 10 includes: a control unit 11 and a control unit 12. The control unit 11 is configured to operably control the first switch Q1, whereas, the control unit 12 is configured to operably control the second switch Q2, so as to switch a coupling relationship of the inductor L with an input power Vin, an output power Vout and a ground level, thereby achieving switching power conversion. In one embodiment, the control unit 11 is configured to operably control the first switch Q1 to operate in a discontinuous conduction mode (DCM) and the control unit 12 is configured to operably control the second switch Q2 to operate in a DCM. In one embodiment, the switching regulator 100 can be, for example, a buck switching regulator, a boost switching regulator or a buck-boost switching regulator, wherein the switching regulator 100 is configured to operably convert the input power Vin to the output power Vout.

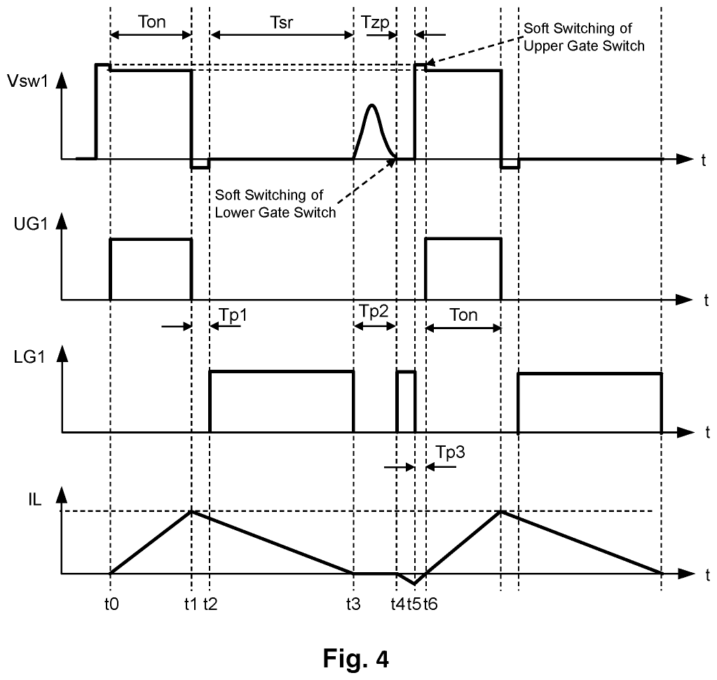

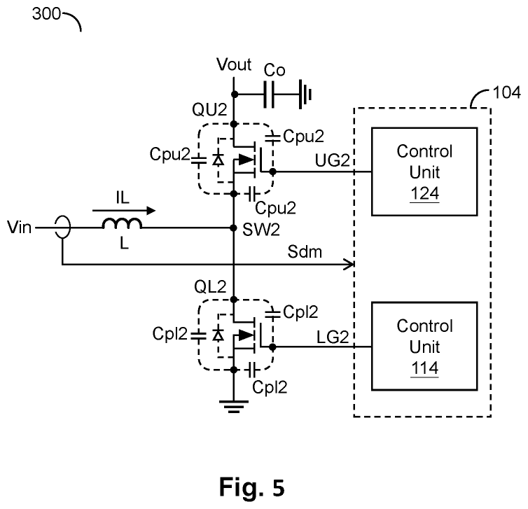

Please refer to FIG. 3 and FIG. 4. FIG. 3 shows a schematic circuit block diagram of a buck switching regulator according to an embodiment of the present invention. FIG. 4 shows waveform diagrams of signals related to the operation of the buck switching regulator of FIG. 3. FIG. 4 shows waveforms of the voltage Vsw1 at the switching node SW1, the control signal UG1, the control signal LG1 and the inductor current IL in FIG. 3. FIG. 3 is an embodiment wherein the switching regulator 100 of FIG. 2 is implemented as a buck switching regulator 200. As shown in FIG. 3, in this embodiment, a first switch of the buck switching regulator 200 corresponds to for example the upper gate switch QU1, whereas, a second switch of the buck switching regulator 200 corresponds to for example the lower gate switch QL1. The upper gate switch QU1 is coupled between the input power Vin and the switching node SW1, whereas, the lower gate switch QL1 is coupled between the switching node SW1 and the ground level. The inductor L is coupled between the switching node SW1 and the output power Vout. As shown in FIG. 3, the inductor L, a parasitic capacitor Cpu1 of the upper gate switch QU1 and a parasitic capacitor Cpl1 of the lower gate switch QL1 together constitute a resonant tank. The control circuit 102 includes: a control unit 111 and a control unit 112. The control unit 111 is configured to operably generate the control signal UG1, whereas, the control unit 112 is configured to operably generate the control signal LG1. The control signal UG1 and the control signal LG1 are configured to operably control the upper gate switch QU1 and the lower gate switch QL1, respectively, so that the switching node SW1 is switched between the input power Vin and the ground level.

Please refer to FIG. 3 in conjugation with FIG. 4. The control unit 112 is configured to operably control the upper gate switch QU1 to be ON for an ON time period Ton (i.e., a time period from the time point t0 to the time point t1). During a dead time period Tp1 subsequent to the ON time period Ton, the control unit 112 controls the upper gate switch QU1 to be OFF and the control unit 122 controls the lower gate switch QL1 to be OFF. During a synchronous rectification (SR) time period Tsr subsequent to the dead time period Tp1, the control unit 122 controls the lower gate switch QL1 to be ON. During a dead time period Tp2 subsequent to the SR time period Tsr, the control unit 112 controls the upper gate switch QU1 to be OFF and the control unit 122 controls the lower gate switch QL1 to be OFF. In this embodiment and in other embodiments, when the output loading condition decreases, the dead time period Tp2 can be prolonged. That “the output loading condition decreases” means that a load circuit which is powered by the output power Vout decreases its power consumption or its current consumption.

During a zero-voltage-switching (ZVS) pulse time period Tzp subsequent to the dead time period Tp2, the control circuit 122 controls the lower gate switch QL1 to be ON for the ZVS pulse time period Tzp. During a dead time period Tp3 subsequent to the ZVS pulse time period Tzp, the control unit 112 controls the upper gate switch QU1 to be OFF and the control unit 122 controls the lower gate switch QL1 to be OFF, whereby the upper gate switch QU1 achieves soft switching during the dead time period Tp3. For example, at a termination time point (e.g., t6) of the dead time period Tp3, i.e., at a starting time point of an ON time period Ton of a following switching period subsequent to the dead time period Tp3, the control unit 112 controls the upper gate switch QU1 to be ON, to achieve soft switching.

In one embodiment, the dead time period Tp1 is a time period between a time point when the upper gate switch QU1 is turned OFF and a time point when the lower gate switch QL1 is turned ON. The dead time period Tp3 is a time period between a time point when the lower gate switch QL1 is turned OFF and a time point when the upper gate switch QU1 is turned ON. In one embodiment, as shown in FIG. 3 and FIG. 4, the SR time period Tsr is determined according to a demagnetization signal Sdm, wherein the demagnetization signal Sdm indicates that the inductor L has been demagnetized. In one embodiment, the demagnetization signal Sdm is obtained according to the inductor current IL.

As shown in FIG. 4, during the ON time period Ton (i.e., a time period from the time point t0 to the time point t1), the inductor current IL is a positive current and keeps increasing. Subsequently, during the SR time period Tsr, the inductor current IL remains positive but is decreasing. During the dead time period Tp2, the inductor current IL is zero. Under such situation, the voltage Vsw1 at the switching node SW1 begins to resonate according to a resonant frequency of the above-mentioned resonant tank. In one embodiment, as shown in FIG. 4, the dead time period Tp2 is correlated with a resonant period of the resonant tank. In one embodiment, the dead time period Tp2 is a multiple of the length of the resonant period, so that when the lower gate switch QL1 is turned ON during the ZVS pulse time period Tzp, the lower gate switch QL1 achieves soft switching. Subsequently, during the ZVS pulse time period Tzp, the inductor current IL becomes a negative current. Subsequently, during the dead time period Tp3, the inductor current IL having a negative sign charges the parasitic capacitor Cpu1 and the parasitic capacitor Cpl1 at the switching node SW1, and a body diode of the upper gate switch QU1 is turned ON, so the voltage Vsw1 at the switching node SW1 increases to a voltage level which is a sum of the input power Vin plus a conduction voltage of the body diode of the upper gate switch QU1. That is, the drain-source voltage of the upper gate switch QU1 is greatly reduced to approximately zero, so that when the upper gate switch QU1 is turned ON at the termination time point (e.g., t6) of the dead time period Tp3 (i.e., at a starting time point of an ON time period Ton of a following switching period subsequent to the dead time period Tp3), the upper gate switch QU1 achieves soft switching.

In one embodiment, the dead time period Tp2 is adjustable. For example, the dead time period Tp2 can be 1-fold, 2-fold or 3-fold of the resonant period. Under such situation wherein the dead time period Tp2 is adjustable, a switching period of the first switch (e.g., the upper gate switch QU1) is adjustable.

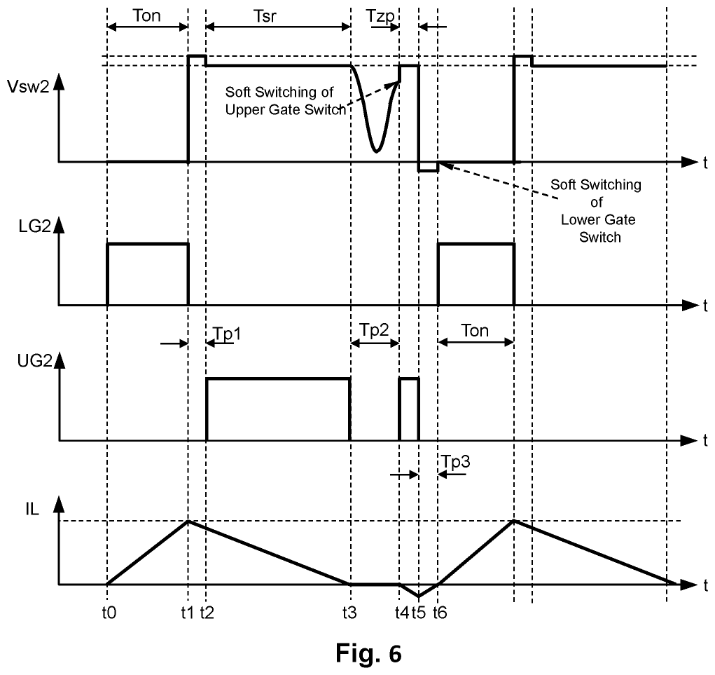

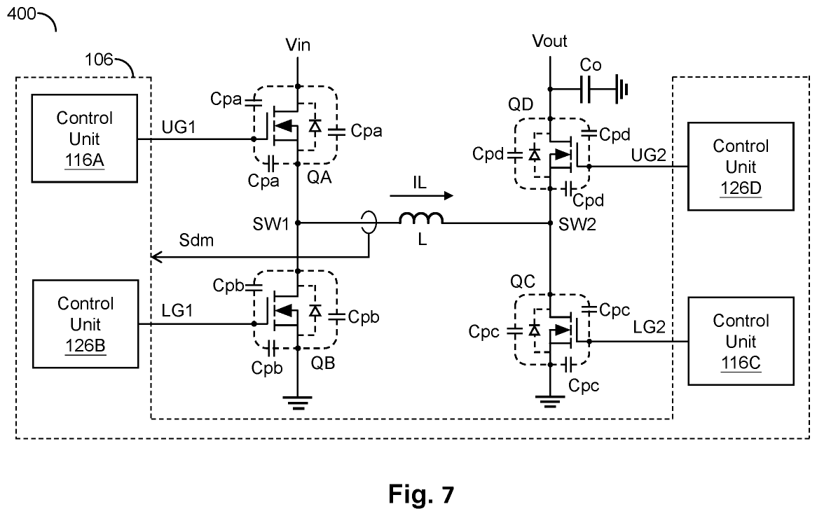

Please refer to FIG. 5 and FIG. 6. FIG. 5 shows a schematic circuit block diagram of a boost switching regulator according to an embodiment of the present invention. FIG. 6 shows waveform diagrams of signals related to the operation of the boost switching regulator of FIG. 5. FIG. 6 shows waveform diagrams of signals related to the operation of the buck switching regulator of FIG. 3. FIG. 6 shows waveforms of the voltage Vsw2 at the switching node SW2, the control signal UG2, the control signal LG2 and the inductor current IL. FIG. 5 is an embodiment wherein the switching regulator 100 of FIG. 2 is implemented as a boost switching regulator 300. As shown in FIG. 5, in this embodiment, a first switch of the boost switching regulator 300 corresponds to for example the lower gate switch QL2, whereas, a second switch of the boost switching regulator 300 corresponds to for example the upper gate switch QU2. The upper gate switch QU2 is coupled between the output power Vout and the switching node SW2, whereas, the lower gate switch QL2 is coupled between the switching node SW2 and the ground level. The inductor Lis coupled between the switching node SW2 and the output power Vout. As shown in FIG. 5, the inductor L, a parasitic capacitor Cpu2 of the upper gate switch QU2 and a parasitic capacitor Cpl2 of the lower gate switch QL2 together constitute a resonant tank. The control circuit 104 includes: a control unit 114 and a control unit 124. The control unit 114 is configured to operably generate the control signal LG2, whereas, the control unit 112 is configured to operably generate the control signal UG2. The control signal UG2 and the control signal LG2 are configured to operably control the upper gate switch QU2 and the lower gate switch QL2, respectively, so that the switching node SW2 is switched between the output power Vout and the ground level.

Please refer to FIG. 5 in conjugation with FIG. 6. The control unit 114 controls the lower gate switch QL2 to be ON for an ON time period Ton (i.e., a time period from the time point t0 to the time point t1). During a dead time period Tp1 subsequent to the ON time period Ton, the control unit 114 controls the lower gate switch QL2 to be OFF and the control unit 124 controls the upper gate switch QU2 to be OFF. During a synchronous rectification (SR) time period Tsr subsequent to the dead time period Tp1, the control unit 124 controls the upper gate switch QU2 to be ON. During a dead time period Tp2 subsequent to the SR time period Tsr, the control unit 114 controls the lower gate switch QL2 to be OFF and the control unit 124 controls the upper gate switch QU2 to be OFF.

During a zero-voltage-switching (ZVS) pulse time period Tzp subsequent to the dead time period Tp2, the control circuit 124 controls the upper gate switch QU2 to be ON. During a dead time period Tp3 subsequent to the ZVS pulse time period Tzp, the control unit 114 controls the lower gate switch QL2 to be OFF and the control unit 124 controls the upper gate switch QU2 to be OFF. By the above operations, the lower gate switch QL2 achieves soft switching during the dead time period Tp3. For example, the control unit 114 controls the lower gate switch QL2 to be ON at a termination time point (e.g., t6) of the dead time period Tp3 (i.e., at a starting time point of an ON time period Ton of a following switching period subsequent to the dead time period Tp3), so that the lower gate switch QL2 achieves soft switching.

In one embodiment, the dead time period Tp1 is a time period between a time point when the lower gate switch QL2 is turned OFF and a time point when the upper gate switch QU2 is turned ON. The dead time period Tp3 is a time period between a time point when the upper gate switch QU2 is turned OFF and a time point when the lower gate switch QL2 is turned ON. In one embodiment, as shown in FIG. 5 and FIG. 6, the SR time period Tsr is determined according to a demagnetization signal Sdm, wherein the demagnetization signal Sdm indicates that the inductor L has been demagnetized. In one embodiment, the demagnetization signal Sdm is obtained according to for example the inductor current IL.

As shown in FIG. 6, during the ON time period Ton (i.e., a time period from the time point t0 to the time point t1), the inductor current IL is a positive current and keeps increasing. Subsequently, during the SR time period Tsr, the inductor current IL remains positive but is decreasing. During the dead time period Tp2, the inductor current IL is zero. Under such situation, the voltage Vsw2 at the switching node SW2 begins to resonate according to a resonant frequency of the above-mentioned resonant tank. In one embodiment, as shown in FIG. 6, the dead time period Tp2 is correlated with a resonant period of the resonant tank. In one embodiment, the dead time period Tp2 is a multiple of the length of the resonant period, so that when the second switch (e.g., the upper gate switch QU2) is turned ON during the ZVS pulse time period Tzp, the second switch achieves soft switching. Subsequently, during the ZVS pulse time period Tzp, the inductor current IL becomes a negative current. Subsequently, during the dead time period Tp3, the inductor current IL having a negative sign discharges the parasitic capacitor Cpu2 and the parasitic capacitor Cpl2 at the switching node SW2, and a body diode of the lower gate switch QL2 is turned ON, so the voltage Vsw2 at the switching node SW2 is decreased to a voltage level which is a difference of the ground voltage minus a conduction voltage of the body diode of the lower gate switch QL2. That is, the drain-source voltage of the lower gate switch QL2 is greatly decreased to approximately zero, so that when the lower gate switch QL2 is turned ON at the termination time point (e.g., t6) of the dead time period Tp3 (i.e., at a starting time point of an ON time period Ton of a following switching period subsequent to the dead time period Tp3), the lower gate switch QL2 achieves soft switching.

In one embodiment, the dead time period Tp2 is adjustable. For example, the dead time period Tp2 can be 1-fold, 2-fold or 3-fold of the resonant period. Under such situation wherein the dead time period Tp2 is adjustable, a switching period of the first switch (e.g., the lower gate switch QL2) is adjustable.

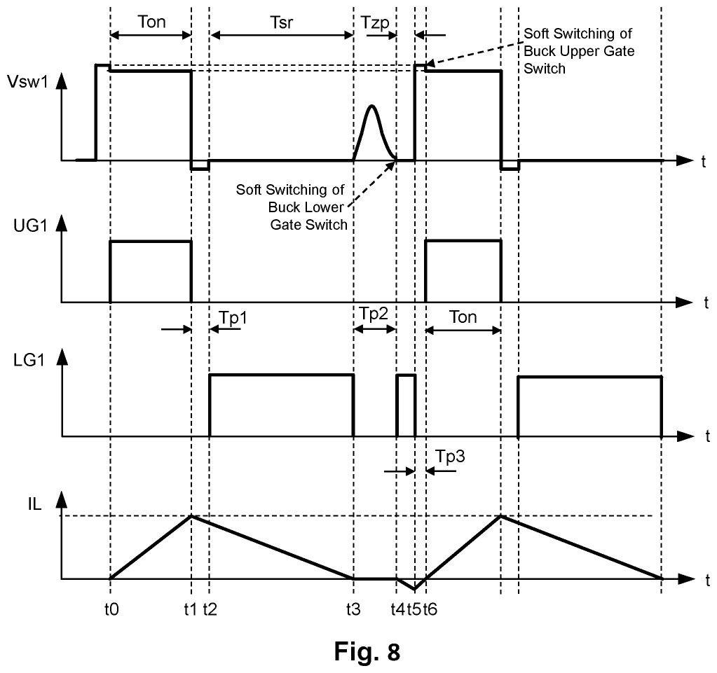

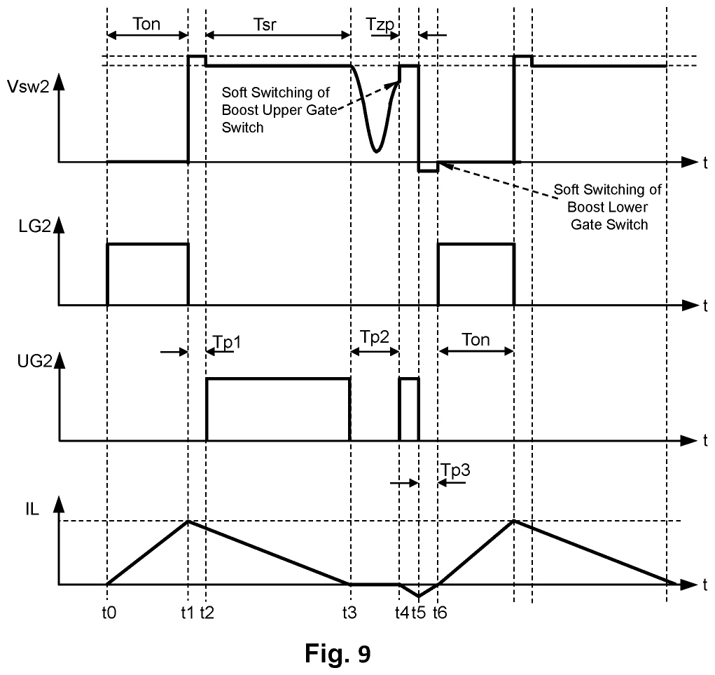

Please refer to FIG. 7, FIG. 8 and FIG. 9. FIG. 7 shows a schematic circuit block diagram of a buck-boost switching regulator according to an embodiment of the present invention. FIG. 8 and FIG. 9 show waveform diagrams of signals related to the operation of the buck-boost switching regulator of FIG. 7. FIG. 8 shows waveforms of the voltage Vsw1 at the switching node SW1, the control signal UG1, the control signal LG1 and the inductor current IL. FIG. 9 shows waveforms of the voltage Vsw2 at the switching node SW2, the control signal UG2, the control signal LG2 and the inductor current IL. FIG. 7 is an embodiment wherein the switching regulator 100 of FIG. 2 is implemented as a buck-boost switching regulator 400. A buck upper gate switch QA is coupled between the input power Vin and the switching node SW1, whereas, a lower gate switch QB is coupled between the switching node SW1 and a ground level. A boost lower gate switch QC is coupled between the second switching node SW2 and the ground level, whereas, a boost upper gate switch QD is coupled between the second switching node SW2 and the output power Vout. An inductor L is coupled between the first switching node SW1 and the second switching node SW2.

In one embodiment, when the buck-boost switching regulator 400 operates for step-down conversion (i.e., when the voltage level of the output voltage Vout is lower than the voltage level of the input voltage Vin), the first switch of the buck-boost switching regulator 400 corresponds to the buck upper gate switch QA, whereas, the second switch of the buck-boost switching regulator 400 corresponds to the buck lower gate switch QB. As shown in FIG. 7, the inductor L, a parasitic capacitor Cpa of the upper gate switch QA and a parasitic capacitor Cpb of the lower gate switch QB together constitute a resonant tank. The control circuit 106 includes: a control unit 116A and a control unit 126B. The control unit 116A is configured to operably generate the control signal UG1, whereas, the control unit 126B is configured to operably generate the control signal LG1. The control signal UG1 and the control signal LG1 are configured to operably control the buck upper gate switch QA and the buck lower gate switch QB, respectively, so that the switching node SW1 is switched between the input power Vin and the ground level.

Please refer to FIG. 7 in conjugation with FIG. 8. The control unit 116A controls the buck upper gate switch QA to be ON for an ON time period Ton (i.e., a time period from the time point t0 to the time point t1). During a dead time period Tp1 subsequent to the ON time period Ton, the control unit 116A controls the buck upper gate switch QA to be OFF and the control unit 126B controls the buck lower gate switch QB to be OFF. During a synchronous rectification (SR) time period Tsr subsequent to the dead time period Tp1, the control unit 126B controls the buck lower gate switch QB to be ON. During a dead time period Tp2 subsequent to the SR time period Tsr, the control unit 116A controls the buck upper gate switch QA to be OFF and the control unit 126B controls the buck lower gate switch QB to be OFF.

During a zero-voltage-switching (ZVS) pulse time period Tzp subsequent to the dead time period Tp2, the control circuit 126B controls the buck lower gate switch QB to be ON. During a dead time period Tp3 subsequent to the ZVS pulse time period Tzp, the control unit 116A controls the buck upper gate switch QA to be OFF and the control unit 122 controls the buck lower gate switch QB to be OFF. By the above operations, the buck upper gate switch QA achieves soft switching. To be more specific, the control unit 116A control the buck upper gate switch QA to be ON at a termination time point (e.g., t6) of the dead time period Tp3 (i.e., at a starting time point of an ON time period Ton of a following switching period subsequent to the dead time period Tp3), so that the buck upper gate switch QA achieves soft switching.

In one embodiment, the dead time period Tp1 is a time period between a time point when the buck upper gate switch QA is turned OFF and a time point when the buck lower gate switch QB is turned ON. The dead time period Tp3 is a time period between a time point when the buck lower gate switch QB is turned OFF and a time point when the buck upper gate switch QA is turned ON.

As shown in FIG. 8, during the ON time period Ton (i.e., a time period from the time point t0 to the time point t1), the inductor current IL is a positive current and keeps increasing. Subsequently, during the SR time period Tsr, the inductor current IL remains positive but is decreasing. During the dead time period Tp2, the inductor current IL zero. Under such situation, the voltage Vsw1 at the switching node SW1 begins to resonate according to a resonant frequency of the above-mentioned resonant tank. In one embodiment, as shown in FIG. 8, the dead time period Tp2 is correlated with a resonant period of the resonant tank. In one embodiment, the dead time period Tp2 is a multiple of the length of the resonant period, so that when the second switch (e.g., the lower gate switch QL1) is turned ON during the ZVS pulse time period Tzp, the second switch achieves soft switching. Subsequently, during the ZVS pulse time period Tzp, the inductor current IL becomes a negative current. Subsequently, during the dead time period Tp3, the inductor current IL having a negative sign charges the parasitic capacitor Cpa and the parasitic capacitor Cpb at the switching node SW1, and a body diode of the buck upper gate switch QA is turned ON, so the voltage Vsw1 at the switching node SW1 is increased to a voltage level which is a sum of the input power Vin plus a conduction voltage of the body diode of the buck upper gate switch QA. That is, the drain-source voltage of the buck upper gate switch QA is greatly decreased to approximately zero, so when the buck upper gate switch QA is turned ON at the termination time point (e.g., t6) of the dead time period Tp3 (i.e., at a starting time point of an ON time period Ton of a following switching period subsequent to the dead time period Tp3), the buck upper gate switch QA achieves soft switching.

In one embodiment, the dead time period Tp2 is adjustable. For example, the dead time period Tp2 can be 1-fold, 2-fold or 3-fold of the resonant period. Under such situation wherein the dead time period Tp2 is adjustable, a switching period of the first switch (e.g., the buck upper gate switch QA) is adjustable.

In another case, when the buck-boost switching regulator 400 operates for step-up conversion (i.e., when the voltage level of the output voltage Vout is higher than the voltage level of the input voltage Vin), the first switch of the buck-boost switching regulator 400 corresponds to the boost lower gate switch QC, whereas, the second switch of the buck-boost switching regulator 400 corresponds to the boost upper gate switch QD. As shown in FIG. 7, the inductor L, a parasitic capacitor Cpd of the boost upper gate switch QD and a parasitic capacitor Cpc of the boost lower gate switch QC together constitute a resonant tank. The control circuit 106 includes: a control unit 116C and a control unit 126D. The control unit 116C is configured to operably generate the control signal LG2, whereas, the control unit 126D is configured to operably generate the control signal UG2. The control signal UG2 and the control signal LG2 are configured to operably control the boost upper gate switch QD and the boost lower gate switch QC, respectively, so that the switching node SW2 is switched between the output power Vout and the ground level.

Please refer to FIG. 7 in conjugation with FIG. 9. The control unit 116C is configured to operably control the boost lower gate switch QC to be ON for an ON time period Ton (i.e., a time period from the time point t0 to the time point t1). During a dead time period Tp1 subsequent to the ON time period Ton, the control unit 116C controls the boost lower gate switch QC to be OFF and the control unit 126D controls the boost upper gate switch QD to be OFF1. During a synchronous rectification (SR) time period Tsr subsequent to the dead time period Tp1, the control unit 126D controls the boost upper gate switch QD to be ON. During a dead time period Tp2 subsequent to the SR time period Tsr, the control unit 116C controls the boost lower gate switch QC to be OFF and the control unit 126D controls the boost upper gate switch QD to be OFF.

During a zero-voltage-switching (ZVS) pulse time period subsequent to the dead time period Tp2, the control circuit 126D controls the boost upper gate switch QD to be ON. During a dead time period Tp3 subsequent to the ZVS pulse time period Tzp, the control unit 116C controls the boost lower gate switch QC to be OFF and the control unit 126D controls the boost upper gate switch QD to be OFF. By the above operations, when the boost lower gate switch QC is turned ON at a termination time point (e.g., t6) of the dead time period Tp3 (i.e., at a starting time point of an ON time period Ton of a following switching period subsequent to the dead time period Tp3), the boost lower gate switch QC achieves soft switching.

In one embodiment, the dead time period Tp1 is a time period between a time point when the boost lower gate switch QC is turned OFF and a time point when the boost upper gate switch QD is turned ON. The dead time period Tp3 is a time period between a time point when the boost upper gate switch QD is turned OFF and a time point when the boost lower gate switch QC is turned ON. In one embodiment, as shown in FIG. 7, FIG. 8 and FIG. 9, the SR time period Tsr is determined according to a demagnetization signal Sdm, wherein the demagnetization signal Sdm indicates that the inductor L has been demagnetized. In one embodiment, the demagnetization signal Sdm is obtained according to for example the inductor current IL. As shown in FIG. 9, during an ON time period Ton (i.e., a time period from the time point t0 to the time point t1), the inductor current IL is a positive current and keeps increasing. Subsequently, during the SR time period Tsr, the inductor current IL remains positive but is decreasing. During the dead time period Tp2, the inductor current IL is zero. Under such situation, the voltage Vsw2 at the switching node SW2 begins to resonate according to a resonant frequency of the above-mentioned resonant tank. In one embodiment, as shown in FIG. 9, the dead time period Tp2 is correlated with a resonant period of the resonant tank. In one embodiment, the dead time period Tp2 is a multiple of the length of the resonant period, so that when the second switch (e.g., the boost upper gate switch QD) is turned ON during the ZVS pulse time period Tzp, the second switch (e.g., the boost upper gate switch QD) achieves soft switching. Subsequently, during the ZVS pulse time period Tzp, the inductor current IL becomes a negative current. Subsequently, during the dead time period Tp3, the inductor current IL having a negative sign discharges the parasitic capacitor Cpd and the parasitic capacitor Cpc at the switching node SW2, and a body diode of the boost lower gate switch QC is turned ON, so the voltage Vsw2 at the switching node SW2 is decreased to a voltage level which is a difference of the ground voltage minus a conduction voltage of the body diode of the boost lower gate switch QC. That is, the drain-source voltage of the boost lower gate switch QC is greatly decreased to approximately zero, so that when the boost lower gate switch QC is turned ON at the termination time point (e.g., t6) of the dead time period Tp3 (i.e., at a starting time point of an ON time period Ton of a following switching period subsequent to the dead time period Tp3), the boost lower gate switch QC achieves soft switching.

In one embodiment, the dead time period Tp2 is adjustable. For example, the dead time period Tp2 can be 1-fold, 2-fold or 3-fold of the resonant period. Under such situation wherein the dead time period Tp2 is adjustable, a switching period of the first switch (e.g., the boost lower gate switch QC) is adjustable.

As described above, advantages of the present invention include: that, when operating in a buck mode, the present invention controls the lower gate switch to execute double switching and generates a negative inductor current during a switching period, so that the upper gate switch achieves soft switching; that, when operating in a boost mode, the present invention controls an upper gate switch to execute double switching and generates a negative inductor current during a switching period, so that the lower gate switch achieves soft switching; and that, via the above-mentioned two operation mechanisms, the present invention can improve switching efficiency and reduce switching loss, and achieve soft switching without requiring extra devices.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A switching regulator, comprising:
a first switch;
a second switch;
an inductor coupled to the first switch and the second switch, wherein the inductor, a parasitic capacitor of the first switch and a parasitic capacitor of the second switch together constitute a resonant tank; and
a control circuit, which is configured to operably control the first switch and the second switch;
wherein: the control circuit is configured to operably control the first switch to be ON for an ON time period; subsequent to the ON time period, the control circuit is configured to operably control the first switch and the second switch to be OFF for a first dead time period; subsequent to the first dead time period, the control circuit is configured to operably control the second switch to be ON for a synchronous rectification (SR) time period; subsequent to the SR time period, the control circuit is configured to operably control the first switch and the second switch to be OFF for a second dead time period; subsequent to the second dead time period, the control circuit is configured to operably control the second switch to be ON for a zero-voltage-switching (ZVS) pulse time period; subsequent to the ZVS pulse time period, the control circuit is configured to operably control the first switch and the second switch to be OFF for a third dead time period, whereby the first switch achieves soft switching.

2. The switching regulator of claim 1, wherein subsequent to the third dead time period, the control circuit is configured to operably control the first switch to be ON for another ON time period, thereby achieving soft switching.

3. The switching regulator of claim 1, wherein the SR time period is determined according to a demagnetization signal, wherein the demagnetization signal indicates that the inductor has been demagnetized.

4. The switching regulator of claim 1, wherein within the ON time period, the inductor generates a positive current.

5. The switching regulator of claim 1, wherein within the ZVS pulse time period, the inductor generates a negative current.

6. The switching regulator of claim 1, wherein the second dead time period is correlated with a resonant period of the resonant tank.

7. The switching regulator of claim 6, wherein the second dead time period is a multiple of the length of the resonant period, so that when the second switch is ON for the ZVS pulse time period, the second switch achieves soft switching.

8. The switching regulator of claim 6, wherein the second dead time period is adjustable, whereby a switching period of the first switch is adjustable.

9. The switching regulator of claim 1, wherein the control circuit is configured to operably control the first switch and the second switch to operate in a discontinuous conduction mode (DCM).

10. The switching regulator of claim 1, wherein the switching regulator is a buck switching regulator, a boost switching regulator or a buck-boost switching regulator, wherein the switching regulator is configured to operably convert an input power to an output power.

11. The switching regulator of claim 1, wherein the switching regulator is a buck switching regulator, which is configured to operably convert an input power to an output power, and the buck switching regulator includes:
an upper gate switch coupled between the input power and a switching node; and
a lower gate switch coupled between the switching node and a ground level;
wherein the inductor is coupled between the switching node and the output power;
wherein the first switch includes the upper gate switch, whereas, the second switch includes the lower gate switch;
wherein the first dead time period is a time period between a time point when the upper gate switch is turned OFF and a time point when the lower gate switch is turned ON;
wherein the third dead time period is a time period between a time point when the lower gate switch is turned OFF and a time point when the upper gate switch is turned ON.

12. The switching regulator of claim 1, wherein the switching regulator is a boost switching regulator, which is configured to operably convert an input power to an output power, and the boost switching regulator includes:
an upper gate switch coupled between the output power and a switching node; and
a lower gate switch coupled between the switching node and a ground level;
wherein the inductor is coupled between the switching node and the input power;
wherein the first switch includes the upper gate switch, whereas, the second switch includes the lower gate switch;
wherein the first dead time period is a time period between a time point when the lower gate switch is turned OFF and a time point when the upper gate switch is turned ON;
wherein the third dead time period is a time period between a time point when the upper gate switch is turned OFF and a time point when the lower gate switch is turned ON.

13. The switching regulator of claim 1, wherein the switching regulator is a buck-boost switching regulator, which is configured to operably convert an input power to an output power, and the buck-boost switching regulator includes:
a buck upper gate switch coupled between the input power and a first switching node; and
a buck lower gate switch coupled between the first switching node and a ground level;
a boost lower gate switch coupled between the second switching node and the ground level; and
a boost upper gate switch coupled between the second switching node and the output power;
wherein the inductor is coupled between the first switching node and the second switching node;
wherein the first switch includes the buck upper gate switch, whereas, the second switch includes the buck lower gate switch;
wherein the first dead time period is a time period between a time point when the buck upper gate switch is turned OFF and a time point when the buck lower gate switch is turned ON;
wherein the third dead time period is a time period between a time point when the buck lower gate switch is turned OFF and a time point when the buck upper gate switch is turned ON.

14. The switching regulator of claim 1, wherein the switching regulator is a buck-boost switching regulator, which is configured to operably convert an input power to an output power, and the buck-boost switching regulator includes:
a buck upper gate switch coupled between the input power and a first switching node; and
a buck lower gate switch coupled between the first switching node and a ground level;
a boost lower gate switch coupled between a second switching node and the ground level; and
a boost upper gate switch coupled between the second switching node and the output power;
wherein the inductor is coupled between the first switching node and the second switching node;
wherein the first switch includes the boost upper gate switch, whereas, the second switch includes the boost lower gate switch;
wherein the first dead time period is a time period between a time point when the boost lower gate switch is turned OFF and a time point when the boost upper gate switch is turned ON;
wherein the third dead time period is a time period between a time point when the boost upper gate switch is turned OFF and a time point when the boost lower gate switch is turned ON.

15. A control circuit, which is configured to operably control a switching regulator, wherein the switching regulator comprises a first switch, a second switch, an inductor coupled to the first switch and the second switch, and the control circuit, wherein the inductor, a parasitic capacitor of the first switch and a parasitic capacitor of the second switch together constitute a resonant tank; the control circuit comprising:
a first control unit, which is configured to operably control the first switch; and
a second control unit, which is configured to operably control the second switch;
wherein: the control circuit is configured to operably control the first switch to be ON for an ON time period; subsequent to the ON time period, the control circuit is configured to operably control the first switch and the second switch to be OFF for a first dead time period; subsequent to the first dead time period, the control circuit is configured to operably control the second switch to be ON for a synchronous rectification (SR) time period; subsequent to the SR time period, the control circuit is configured to operably control the first switch and the second switch to be OFF for a second dead time period; subsequent to the second dead time period, the control circuit is configured to operably control the second switch to be ON for a zero-voltage-switching (ZVS) pulse time period; subsequent to the ZVS pulse time period, the control circuit is configured to operably control the first switch and the second switch to be OFF for a third dead time period, whereby the first switch achieves soft switching.

16. The control circuit of claim 15, wherein subsequent to the third dead time period, the control circuit is configured to operably control the first switch to be ON for another ON time period, thereby achieving soft switching

17. The control circuit of claim 15, wherein the SR time period is determined according to a demagnetization signal, wherein the demagnetization signal indicates that the inductor has been demagnetized.

18. The control circuit of claim 15, wherein within the ON time period, the inductor generates a positive current.

19. The control circuit of claim 15, wherein within the ZVS pulse time period, the inductor generates a negative current.

20. The control circuit of claim 15, wherein the second dead time period is correlated with a resonant period of the resonant tank.

21. The control circuit of claim 20, wherein the second dead time period is a multiple of the length of the resonant period, so that when the second switch is ON for the ZVS pulse time period, the second switch achieves soft switching.

22. The control circuit of claim 20, wherein the second dead time period is adjustable, which accordingly causes a switching period of the first switch is adjustable.

23. The control circuit of claim 15, wherein the first control unit is configured to operably control the first switch to operate in a discontinuous conduction mode (DCM) and the second control unit is configured to operably control the second switch to operate in a DCM.

24. The control circuit of claim 15, wherein the switching regulator is a buck switching regulator, a boost switching regulator or a buck-boost switching regulator, wherein the switching regulator is configured to operably convert an input power to an output power.

25. The control circuit of claim 15, wherein the switching regulator is a buck switching regulator, which is configured to operably convert an input power to an output power, and the buck switching regulator includes:
an upper gate switch coupled between the input power and a switching node; and
a lower gate switch coupled between the switching node and a ground level;
wherein the inductor is coupled between the switching node and the output power;
wherein the first switch includes the upper gate switch, whereas, the second switch includes the lower gate switch;
wherein the first dead time period is a time period between a time point when the upper gate switch is turned OFF and a time point when the lower gate switch is turned ON;
wherein the third dead time period is a time period between a time point when the lower gate switch is turned OFF and a time point when the upper gate switch is turned ON.

26. The control circuit of claim 15, wherein the switching regulator is a boost switching regulator, which is configured to operably convert an input power to an output power, and the boost switching regulator includes:
an upper gate switch coupled between the output power and a switching node; and
a lower gate switch coupled between the switching node and a ground level;
wherein the inductor is coupled between the switching node and the input power;
wherein the first switch includes the upper gate switch, whereas, the second switch includes the lower gate switch;
wherein the first dead time period is a time period between a time point when the lower gate switch is turned OFF and a time point when the upper gate switch is turned ON;
wherein the third dead time period is a time period between a time point when the upper gate switch is turned OFF and a time point when the lower gate switch is turned ON.

27. The control circuit of claim 15, wherein the switching regulator is a buck-boost switching regulator, which is configured to operably convert an input power to an output power, and the buck-boost switching regulator includes:
a buck upper gate switch coupled between the input power and a first switching node; and
a buck lower gate switch coupled between the first switching node and a ground level;
a boost lower gate switch coupled between the second switching node and the ground level; and
a boost upper gate switch coupled between the second switching node and the output power;
wherein the inductor is coupled between the first switching node and the second switching node;
wherein the first switch includes the buck upper gate switch, whereas, the second switch includes the buck lower gate switch;
wherein the first dead time period is a time period between a time point when the buck upper gate switch is turned OFF and a time point when the buck lower gate switch is turned ON;
wherein the third dead time period is a time period between a time point when the buck lower gate switch is turned OFF and a time point when the buck upper gate switch is turned ON.

28. The control circuit of claim 15, wherein the switching regulator is a buck-boost switching regulator, which is configured to operably convert an input power to an output power, wherein the buck-boost switching regulator includes:
a buck upper gate switch coupled between the input power and a first switching node; and
a buck lower gate switch coupled between the first switching node and a ground level;
a boost lower gate switch coupled between a second switching node and the ground level; and
a boost upper gate switch coupled between the second switching node and the output power;
wherein the inductor is coupled between the first switching node and the second switching node;
wherein the first switch includes the boost upper gate switch, whereas, the second switch includes the boost lower gate switch;
wherein the first dead time period is a time period between a time point when the boost lower gate switch is turned OFF and a time point when the boost upper gate switch is turned ON;
wherein the third dead time period is a time period between a time point when the boost upper gate switch is turned OFF and a time point when the boost lower gate switch is turned ON.
